(19) United States
(12) Patent Application Publication
(10) Pub. No.: US 2018/0368166 A1
(43) Pub. Date: Dec. 20, 2018

(54) USER EQUIPMENT AND METHOD TO SUPPORT DATA PREPROCESSING

(71) Applicant: MediaTek Inc., Hsin-Chu (TW)

(72) Inventors: Yu-Syuan Jheng, Hsin-Chu (TW); Pavan Santhana Krishna Nuggehalli, San Jose, CA (US); Chia-Chun Hsu, Hsin-Chu (TW); Per Johan Mikael Johansson, Solaris (SG)

(21) Appl. No.: 16/009,045

(22) Filed: Jun. 14, 2018

Related U.S. Application Data
(60) Provisional application No. 62/544,100, filed on Aug. 11, 2017.
(60) Provisional application No. 62/523,344, filed on Jun. 22, 2017.
(60) Provisional application No. 62/520,786, filed on Jun. 16, 2017.

(51) Int. Cl. H04W 72/12; H04W 72/14

(52) U.S. Cl. CPC H04W 72/1284; H04W 72/14

(57) ABSTRACT

Described herein are a method and a mobile communication device that support data preprocessing in a mobile communication system, and in particular, a method and a mobile communication device to report buffer status that can indicate an amount of preprocessed data, for example when using 5G NR technology. An amount of preprocessed data is determined and transmitted to a network element by a user equipment (UE) in a buffer status report (BSR).

### CROSS-REFERENCE TO RELATED APPLICATIONS

This application claims the benefit under 35 U.S.C. § 119(e) of U.S. patent application Ser. No. 62/544,100, filed Aug. 11, 2017, entitled “BSR FOR 5G NR PREPROCESSING,” of U.S. patent application Ser. No. 62/523,344, filed Jun. 22, 2017, entitled “USER EQUIPMENT AND METHOD TO SUPPORT DATA PREPROCESSING,” and of U.S. Patent Application Ser. No. 62/520,786, filed Jun. 16, 2017, entitled “USER EQUIPMENT AND METHOD TO SUPPORT DATA PREPROCESSING,” all of which are hereby incorporated herein by reference in their entirety.

### BACKGROUND

The present application relates generally to methods and apparatus for mobile communication. In particular, it relates to generation and transmission of a buffer status report (BSR).

The following is a list of abbreviations that may be found in the specification and/or the drawings.
5G NB 5G Node B
5G RAN 5G Radio Access Network
ACK Acknowledgement
ARQ Automatic Repeat Request
AS Access Stratum
BLER Block Error Rate
BSR Buffer Status Reporting
CE Control Element
CQI Channel Quality Indicator
DC Dual Connectivity
DL Downlink
D-SACK Duplicate Selective Acknowledgement
eNB Node B (LTE base station)
EN-DC LTE and NR dual connectivity
gNB gNode B (5G base station)
HARQ Hybrid ARQ
IP Internet Protocol
L2 Layer 2 (data link layer)
LCG Logical Channel Group
LTE Long Term Evolution
MAC Medium Access Control
NAS Non-access Stratum
NR New Radio (5G)
NSA Non-standalone Architecture
NW Network
PDCP Packet Data Convergence Protocol
PDU Protocol Data Unit
PHY Physical layer
RAN Radio Access Network
RLC Radio Link Control
RLF Radio Link Failure
RLM Radio Link Monitoring
RS Reference Signal
SDAP Service Data Adaptation Protocol
SDU Service Data Unit
TB Transport Block
TCP Transmission Control Protocol
TTI Time Transmission Interval
UE User Equipment
UL Uplink

In a mobile communication system, a UE such as a mobile communication device may establish a link with a network element such as a cellular base station referred to as eNB for LTE, or gNB for 5G. The UE may communicate with the network element by transmitting or receiving voice and/or data signals.

An UE typically comprises a user plane protocol stack having multiple protocol layers such as PDCP, RLC and MAC, as arranged from upper protocol layers to lower protocol layers. During an uplink transmission from the UE to the network element, data within the UE flows from an upper protocol layer to a lower protocol layer. In general, the data entity from/to a higher protocol layer is known as a service data unit (SDU) and the corresponding entity to/from a lower protocol layer entity is called a protocol data unit (PDU). FIG. 1 shows a schematic diagram of an exemplary data flow in the user plane protocol stack of a UE that is part of a mobile communication system using LTE technology. During an uplink transmission, the PDCP processes data received from the protocol layer above (shown as IP layer in FIG. 1) in the form of a PDCP SDU, such as performing ciphering and/or header compression. PDCP then generates and adds a PDCP header, which carries information required for deciphering. The output from the PDCP is in the form of a PDCP PDU, and is forwarded to the RLC. The RLC receives the output from the PDCP as RLC SDU, and performs concatenation and/or segmentation of the RLC SDUs and adds an RLC header. The RLC PDUs are forwarded to the MAC layer, which multiplexes a number of RLC PDUs and attaches a MAC header to form a transport block for transmission by the UE in the physical layer. In each of the PDCP, RLC and MAC layers, processed data are the respective PDU that comprises a generated header in the layer.

In LTE, when there is data available for transmission to a network element, the UE may perform a buffer status reporting procedure to provide information about the amount of data available for transmission in UL buffers within the UE. A buffer status report (BSR) may be generated by the UE and transmitted to a cellular base station eNB to provide such information. In LTE, calculation of data available for transmission includes both processed and unprocessed data in RLC and PDCP layers, according to for example 3GPP TS36.322 v14.0.0 and TS36.323 v14.1.0.

When the UE sends a request for transmission to eNB, the eNB may respond with an uplink (UL) grant authorizing transmission from the eNB. The UL grant provides information such as an amount of resource allocated for the UE to transmit the requested data by a particular time of transmission.

### SUMMARY

According to some embodiments, a method for transmitting data in a mobile communication system by a user equipment (UE) is provided. The method comprises determining a first value based on an amount of processed data comprising at least one protocol data unit (PDU) with a packet data convergence protocol (PDCP) header; generating a buffer status report (BSR) comprising the first value; and transmitting the BSR to a network element.

According to some embodiments, a mobile communication device for transmitting data to a network element in a mobile communication system is provided. The mobile communication device comprises at least one processor; and at least one memory having instructions that, when executed by the at least one processor, cause the mobile communication device to perform a method for transmitting data by the mobile communication device to the network element. The method comprises determining a first value based on an amount of processed data having at least one protocol data unit (PDU) with a packet data convergence protocol (PDCP) header; generating a buffer status report (BSR) comprising the first value; and transmitting the BSR to a network element.

According to some embodiments, a method for transmitting data in a mobile communication system by a user equipment (UE). The method comprises receiving an uplink (UL) grant from a network element for transmitting a first amount of data; determining whether a second amount of preprocessed data is smaller than the first amount. The method further comprises when the second amount is determined to be smaller than the first amount, transmitting padding bits with the preprocessed data, and an indication that unprocessed data is available for transmission to the network element.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram of an exemplary data flow in the user plane protocol stack of a UE that is part of a mobile communication system using LTE technology y;

FIG. 2 is a schematic diagram of an exemplary data flow 200 in the user plane protocol architecture of a UE in communication with a gNB in 5G NR;

FIG. 3 is a schematic diagram of a mobile communication system 300, in accordance with some embodiments;

FIG. 4A is a flow chart of a method 400 for transmitting data in a mobile communication system, in accordance with some embodiments;

FIG. 4B is a flow chart of a method 500 for transmitting data in a mobile communication system, in accordance with some embodiments;

FIG. 5A is a schematic diagram of an exemplary short-form BSR 600, in accordance with some embodiments;

FIG. 5B is a schematic diagram of an exemplary long-form BSR 700, in accordance with some embodiments;

FIG. 6 is a look-up table between buffer size level indexes, and buffer byte sizes;

FIG. 7 is a schematic diagram showing preprocessing in dual-connectivity scenario with offsets;

FIG. 8 is a flow chart of a method 800 for transmitting data in a mobile communication system, in accordance with some embodiments.

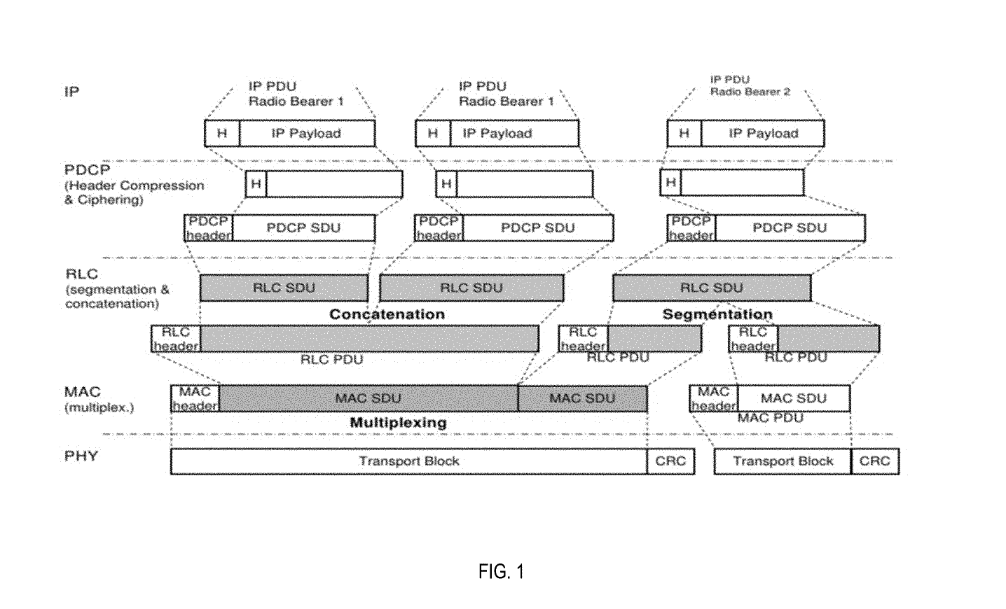

### DETAILED DESCRIPTION

Disclosed here is a method and a mobile communication device that support data preprocessing in a mobile communication system, and in particular, a method and a mobile communication device to report buffer status that can indicate an amount of preprocessed data, for example when using 5G NR technology.

Compared to LTE, 5G NR is expected to provide much higher data rate and lower latency. Consequently, the interval between the time of receiving UL grant and the time for data transmission is expected to become significantly shorter in 5G NR compared to in LTE for UE to process data from an SDU in a higher layer into a PDU for a lower layer in the user plane protocol stack. In cases of high data rate transmission, the UE may not have enough processing time to prepare processed data to fill the complete amount of allocated data in the UL grant before time of transmission, and radio resource will be wasted. The inventors have appreciated and acknowledged that it is desirable for L2 protocol functions in NR to be simplified to shorten the processing time within the user plane protocol layers. One way to shorten processing time is to enable preprocessing of part of or all the data available for transmission, prior to receiving the UL grant.

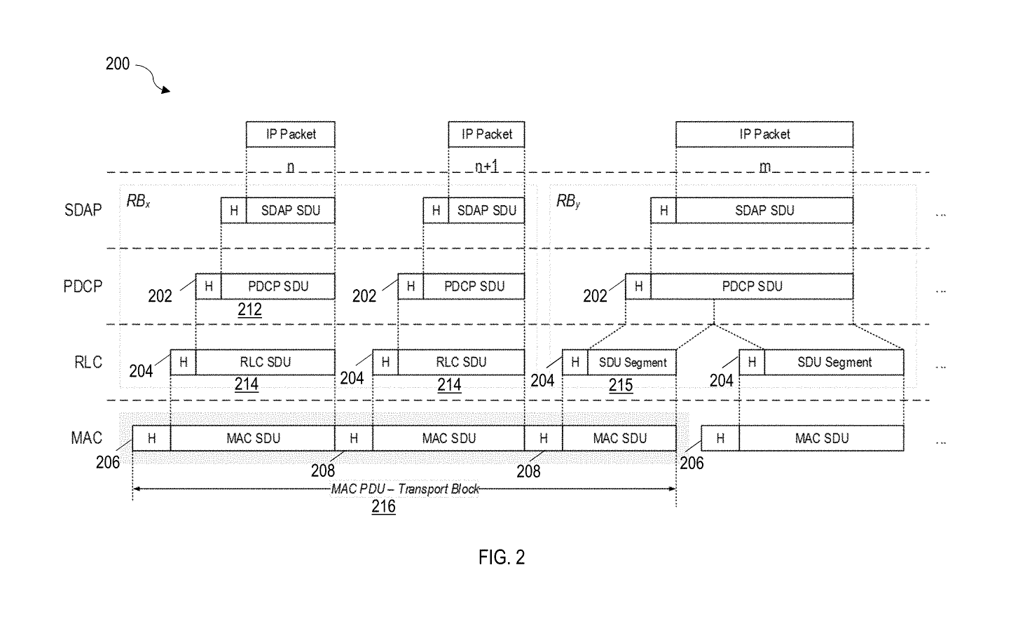

FIG. 2 is a schematic diagram of an exemplary data flow 200 in the user plane protocol architecture of a UE in communication with a gNB in 5G NR. As shown in FIG. 2, the user plane protocol of UE comprises sublayers SDAP, PDCP, RLC and MAC, with ‘H’ denoting the PDCP headers 202, RLC headers 204, MAC headers 206 and MAC subheaders 208 of the processed PDUs in each layer. For example, PDCP PDU 212 may be a processed data with a PDCP header 202. RLC PDU 214 may be a processed data with an RLC header 204, as well as a PDCP header from the RLC SDU received from the PDCP layer above. MAC PDU 216 may be a processed data with a MAC header 206 as well as a RLC header and a PDCP header from the MAC SDU(s) received from the RLC layer above. MAC PDU 216 may also have one or more MAC subheader 208.

Referring to FIG. 2, a MAC PDU 216 is generated by MAC as a transport block by concatenating two RLC PDUs 214 from RBₓ and one RLC PDU 215 from RB_{y}. The two RLC PDUs 214 from RBₓ each corresponds to one IP packet (n and n+1) while the RLC PDU 215 from RB_{y} is a segment of an IP packet (m). The inventors have appreciated that preprocessing may be enabled for for all layers of the protocol stack, from PDCP to MAC, before the UE receives the UL grant. According to an aspect of the present application, to shorten the processing time within the user plane protocol layers, a UE may perform preprocessing to generate preprocessed data that comprises at least one PDU with a PDCP header, or at least one PDU with a PDCP header and a RLC header, or at least one PDU with a PDCP header, a RLC header and a MAC header. For 5G NR, if concatenation is removed as a process from the RLC layer as shown in FIG. 2, the UE would have to generate MAC, RLC, and PDCP headers for every IP (or higher layer) packet. In one example in 5G NR, preprocessed data refers to a set of processed MAC PDUs whose PDCP, RLC and MAC headers have been generated.

The inventors have appreciated that when NR relies on preprocessing to cope with the significantly shorter processing time between UL grant reception and transmission, there may be times when the UE is unable to preprocess all packets available at the PDCP layer within the time it takes to send a BSR and receive an UL grant. In one scenario, when traffic is bursty in nature, the UE may be unable to spread the pre-processing load evenly over time and unable to pre-process such a burst of packets in time. In another scenario, since processing load is related to number of packets, UE processing requirement can become challenging when the UL traffic consists of a large fraction of small-sized packets. As the UE adds RLC and MAC headers for each PDCP SDU in NR, the processing load is a function of the number of PDCP PDUs being generated. Therefore when the UL traffic consists of a large fraction of small-sized packets, a large number of PDCP SDUs and correspondingly, a large number of RLC and MAC headers may need to be preprocessed by the UE, which will present a challenge to the UE's processing capacity.

When the UE indicates a full buffer BSR, by for example reporting an total amount of data including both processed and unprocessed data in the BSR, the gNB may over-schedule the radio resource as data that has not been preprocessed is not available to be transmitted timely. In the case of NR, the UE may have completed preprocessing of only part of the data available for transmission. If the gNB provides a grant equal to the requested BSR, then it is possible that the UE will not be able to process headers (for the unprocessed data) in time to meet the uplink transmission deadline. By filling the UL grant with padding, the UE not only wastes radio resources but also potentially sends the wrong signal to the gNB that its buffer is empty.

According to an aspect of the present application, the inventors have appreciated and acknowledged that in order to avoid over-allocation, the UE may be configured to determine a first value based on the amount of preprocessed data available for transmission in the BSR. In one embodiment, the amount of preprocessed data may be an amount of processed data that comprises a set of PDUs whose PDCP, RLC and MAC headers have already been generated. According to another aspect, reporting only the amount of preprocessed data may lead to under-reporting of the data that is available for transmission at the actual instant of transmission. Since there is some delay between the time the BSR is received, and the time the UE needs to transmit, it is expected that the UE will be able to pre-process additional data during this time. In some embodiments, the UE may be configured to estimate an amount of preprocessed data that will be available by a first time, and transmit a BSR to the gNB that comprises a value based on the estimated amount of preprocessed data. For example, the first time may be a time when the data becomes first available for transmission by the UE.

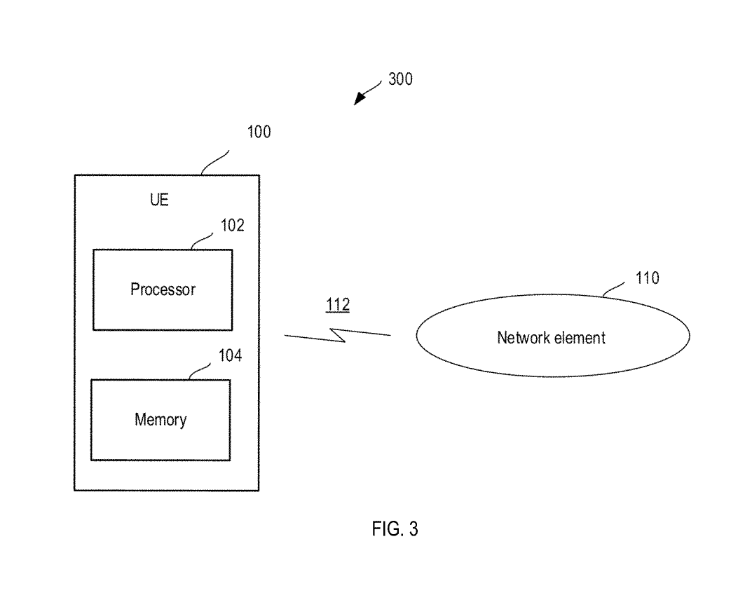

FIG. 3 is a schematic diagram of a mobile communication system 300, in accordance with some embodiments. In FIG. 3, mobile communication system 300 includes UE 100 in connection 112 with a network element 110, in accordance with some embodiments. The UE 100 may be a mobile communication device that comprises one or more processors 102 and one or more memories 104. The at least one memories 104 are configured to store executable instructions or codes that, when executed by the at least one processors 102, cause the UE 100 to perform a method for transmitting or receiving signals with the network element 110 as described throughout the present application. The at least one memories 104 are also configured to store data to be transmitted to or received from the network element. The network element 110 may be a gNB, or an eNB. Although only one network element 110 is shown connected with the UE 100, it should be appreciated that aspects of the present application are not limited to single connectivity scenarios, and are also applicable to other scenarios such as dual connectivity or multi-connectivity with any combination of eNB and gNB.

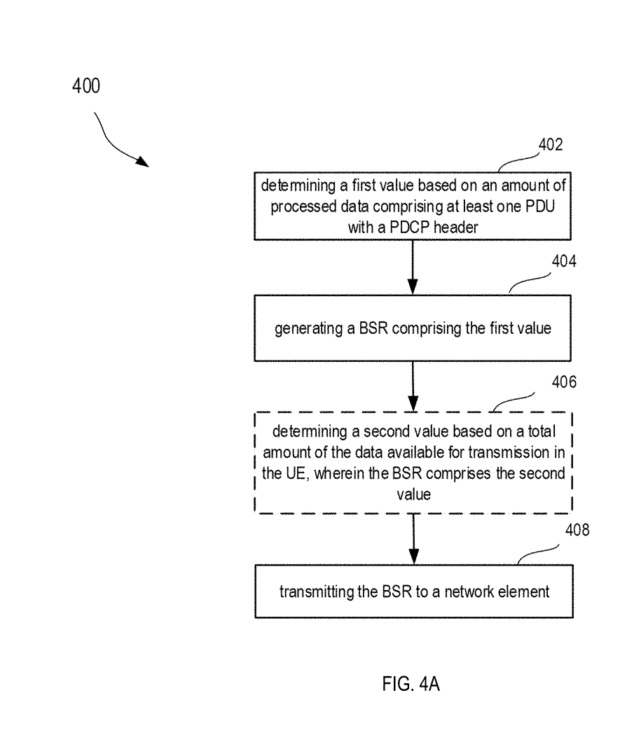

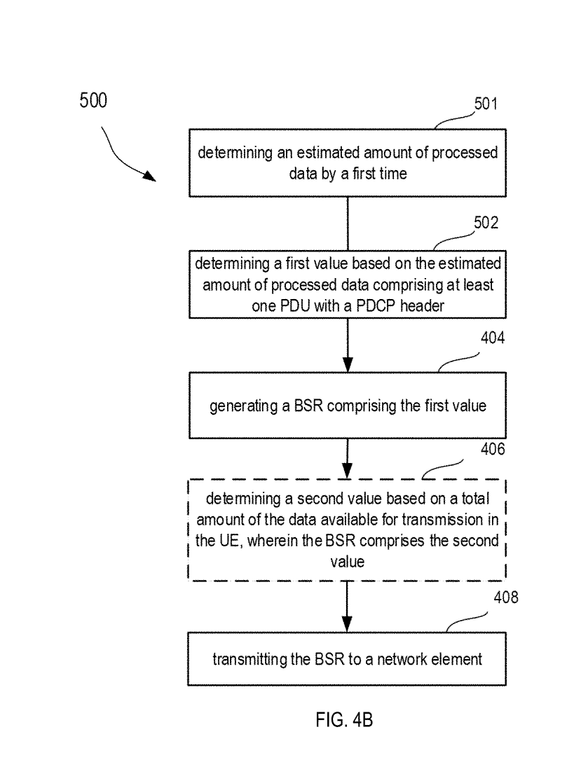

FIG. 4A is a flow chart of a method 400 for transmitting data in a mobile communication system, in accordance with some embodiments. As shown in FIG. 4A, at act 402, method 400 comprises determining a first value based on an amount of processed data comprising at least one PDU with a PDCP header. In some embodiments, the amount of processed data comprising at least one PDU with a PDCP header is the amount of preprocessed data in the UE. It is recognized that any suitable methodology for calculating data amounts in the user plane may be used to calculate the amount of preprocessed data and to determine the value based on the calculated amount. At act 404, method 400 comprises generating a BSR comprising the first value. Optionally at act 406, method 400 further comprises determining a second value based on a total amount of the data available for transmission in the UE, wherein the BSR comprises the second value, such that the BSR may indicate both the amount of preprocessed data and the total amount of available data to the network element. At act 408, method 400 comprises transmitting the BSR to a network element.

FIG. 4B is a flow chart of a method 500 for transmitting data in a mobile communication system, in accordance with some embodiments. Method 500 is similar to method 400 as shown in FIG. 4A in many aspects, and like acts are labeled with the same reference number. Method 500 differs from method 500 in that at act 501, method 500 comprises determining an estimated amount of processed data by a first time. At act 502, method 500 comprises determining a first value based on the estimated amount of processed data comprising at least one PDU with a PDCP header.

According to an aspect of the present application, the UE is configured to indicate the total amount of data available for transmission as well as the amount of data that is pre-processed by transmitting a BSR to the gNB. With the “detailed” BSR, the gNB has a better picture of the UE's buffer status, and can schedule UL grants accordingly.

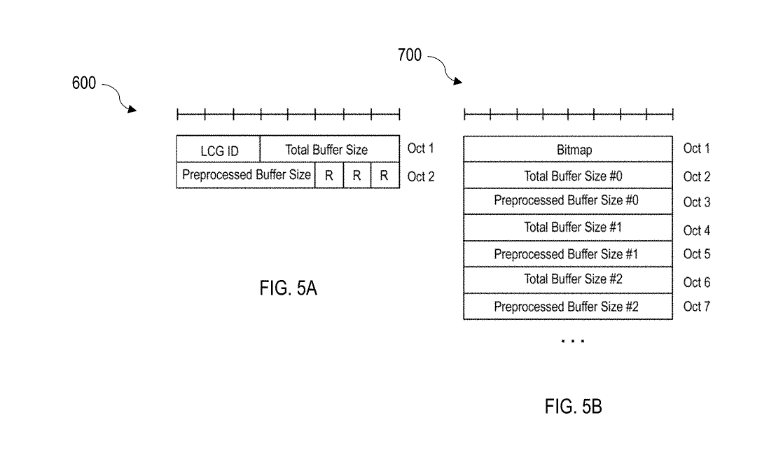

FIG. 5A is a schematic diagram of an exemplary short-form BSR 600, in accordance with some embodiments. Short-form BSR 600 comprises a 3-bit LCG ID field, a 6-bit field to indicate total buffer size, and another 6-bit field to indicate preprocessed buffer size. It should be appreciated that the number of octets and bit-length for each field in BSR 600 is for illustrative purpose only and aspects of the present application are not limited to such values. In some embodiments, the bit length for the value based on total buffer size or preprocessed buffer size may be 3, 4, 5, 6, 7, 8, at least 5, at least 6, or any other suitable bit length for transmission in a BSR. According to an aspect, the preprocessed buffer size field may comprise a first value based on an amount of processed data, and the total buffer size field may comprise a second value based on a total amount of available data for transmission in a UE.

FIG. 5B is a schematic diagram of an exemplary long-form BSR 700, in accordance with some embodiments. Long-form BSR 700 may be used to indicate buffer sizes for a plurality of logical channels. As shown in FIG. 5B, BSR 700 comprises an 8-bit field in octet 2 configured to indicate total buffer size for LCG ID 0, and 8-bit field in Oct 3 to indicate preprocessed buffer size for LCG ID 0. BSR 700 also comprises an 8-bit field in octet 3 configured to indicate total buffer size for LCG ID 1, and 8-bit field in Oct 4 to indicate preprocessed buffer size for LCG ID 1. BSR 700 further comprises an 8-bit field in octet 6 configured to indicate total buffer size for LCG ID 2, and 8-bit field in Oct 7 to indicate preprocessed buffer size for LCG ID 2. It should be appreciated that the number of LCG IDs, the number of octets and bit-length for each field in BSR 700 is for illustrative purpose only and aspects of the present application are not limited to such values. In some embodiments, the bit length for the value based on total buffer size or preprocessed buffer size may be 3, 4, 5, 6, 7, 8, at least 5, at least 6, or any other suitable bit length for transmission in a BSR. According to an aspect, each preprocessed buffer size field may comprise a first value based on an amount of processed data for a given logical channel, and each total buffer size field may comprise a second value based on a total amount of available data for transmission in a UE.

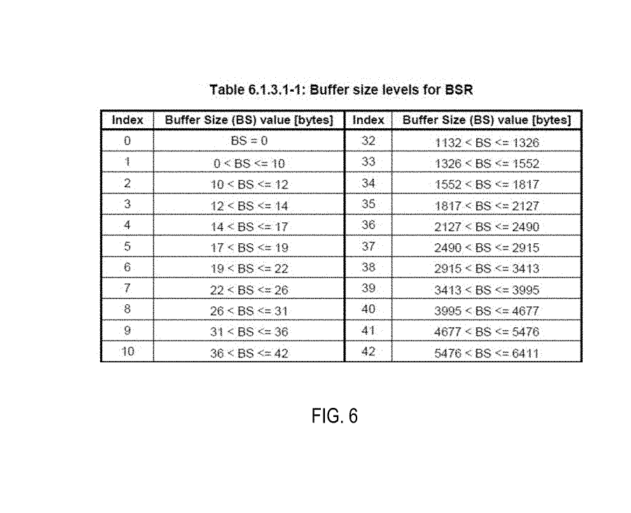

Referring back to FIG. 5A, it should be appreciated that any suitable ways may be used for the value stored in the field “preprocessed buffer size” to indicate the amount of preprocessed data. The value may be a direct numerical representation of the amount of preprocessed data. In some embodiments, a mapping index may be used such that the value in the field “preprocessed buffer size” is an index based on the byte size of the amount of preprocessed data, according to the look-up table shown in FIG. 6 as a non-limiting example.

According to some further aspects, additional BSR enhancements may be made to allow the gNB to better predict the amount of data that will be processed by the UE. In one aspect, the UE may report the amount of data it can pre-process per TTI. This information can be used by the gNB scheduler to determine how much UL grant to provide. In another aspect, the UE may report data that can be processed by time N+t₁, where N corresponds to the subframe when the BSR was sent, and t₁ is some preconfigured duration (e.g., 1 ms or 2 ms). Based on this information, the gNB can estimate the UE's per TTI processing capability and schedule accordingly. In yet another aspect, the UE may report the time (N+t₂) when it expects to finish pre-processing of the reported unprocessed data.

Aspects of the present application are directed to BSR enhancements for dual or multi-connectivity scenarios. In a UL split bearer scenario, when data is below the threshold, similar solution to single connectivity as discussed above may be employed. According to an aspect, when data is above the threshold for DC, it is possible for UE to have two versions of the same data preprocessed differently for each link. When a SDU has been transmitted on one link, the preprocessed version of the SDU for the other link may be removed and not transmitted again there (unless packet duplication is configured). It is recognized that this solution may create RLC SN gaps during transmission which would delay packet receiving in the receiver side. This can be further improved by adding PDU discard function into NR RLC. Upon detecting an event to trigger PDU discard (e.g., detection of a SDU has been successfully sent in another link in our above example), RLC sender shall be possible to indicate such discard information to RLC receiver, e.g., either in the RLC header of next sending PDU or by particular RLC message. Upon receiving the discard information, RLC receiver shall consider those PDUs as received and no longer wait for them. Such an embodiment may save RLC receiver from large delay on waiting the PDUs which are not going to be arrived.

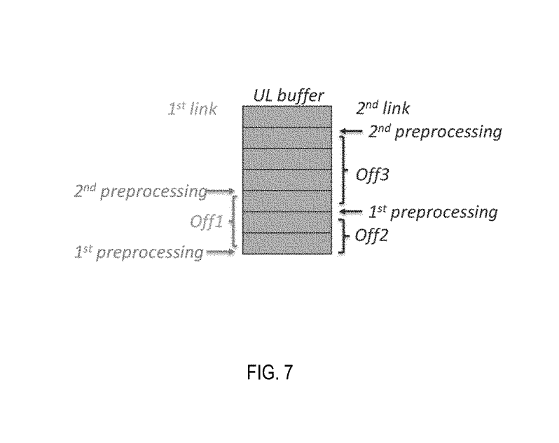

In an alternative embodiment for DC, UE starts preprocessing data from different points in the UL buffer for each link sequentially. The first link starts preprocessing data from the origin of the UL buffer (i.e., data first in) and jumping to an offset (e.g., Off1) for the next preprocessing operation. The second link initially starts preprocessing data from an offset (e.g., Off2, may not be identical to Off1) of the UL buffer and jumping another offset (e.g., Off3, may not be identical to Off1 or Off2) for next preprocessing operation. FIG. 7 is a schematic diagram showing preprocessing in dual-connectivity scenario with offsets.

A further aspect of the present application is directed to a method of providing padding bits by the UE to provide the gNB with a notice that the UE is unable to process headers in time to meet the uplink transmission deadline indicated in the received UL grant. It should be recognized that the UE may waste radio resources by filling the UL grant with padding. The UE also potentially confuses the gNB scheduler by sending a (wrong) signal that its buffer is empty. In order to mitigate these problems, the UE may be allowed to provide a cause for why padding is included. The UE can explicitly indicate that the padding is in response to not being able to process headers in time rather than its buffer being empty. According to an aspect, different logical channel ID may be used for padding BSR of different purposes. The UE may select the LCID in a MAC subheader based on the reason of the padding. If the reason of padding BSR is because of the UE is not able to process the data in time, the UE shall use a LCID different with the one used for normal padding.

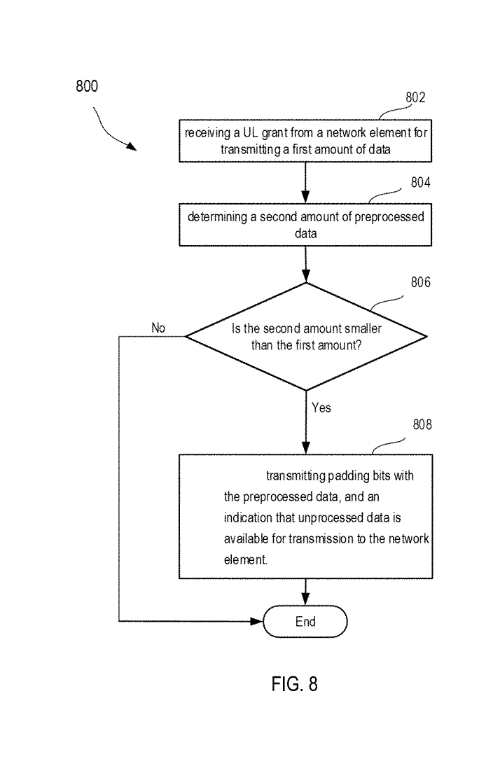

FIG. 8 is a flow chart of a method 800 for transmitting data in a mobile communication system, in accordance with some embodiments. As shown in FIG. 8, at act 802, method 800 comprises receiving a UL grant from a network element for transmitting a first amount of data. At act 804, method 800 comprises determining a second amount of preprocessed data. At act 806, method 800 comprises comparing the second amount with the first amount. If the comparison is positive, the method proceeds to act 808, which comprises transmitting padding bits with the preprocessed data, and an indication that unprocessed data is available for transmission to the network element.

Having thus described several aspects of at least one embodiment of this invention, it is to be appreciated that various alterations, modifications, and improvements will readily occur to those skilled in the art.

For example, although preprocessing of data available for transmission in the context of 5G NR technology is used in the above discussions, aspects of the present application are not limited to 5G NR and may apply to mobile communication systems operating under other technology such as LTE. In one non-limiting example in LTE, a BSR may be generated and transmitted by the UE to indicate an amount of PDUs processed to have PDCP headers generated. The BSR may also include an amount of the set of RLC PDUs to be retransmitted by the UE. In another example in LTE, the UE may be configured to estimate an amount of processed data whose PDCP headers will be generated by the earliest possible transmission time, and a BSR to indicate such an estimated amount of data.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for transmitting data in a mobile communication system by a user equipment (UE), the method comprising:
determining a first value based on an amount of processed data comprising at least one protocol data unit (PDU) with a packet data convergence protocol (PDCP) header;
generating a buffer status report (BSR) comprising the first value;
transmitting the BSR to a network element.

2. The method of claim 1, further comprising determining a second value based on a total amount of the data available for transmission in the UE, wherein the BSR comprises the second value.

3. The method of claim 1, wherein the at least one PDU comprises a radio link control (RLC) header.

4. The method of claim 3, wherein the at least one PDU comprises a medium access control (MAC) header.

5. The method of claim 1, further comprising determining an estimated amount of processed data by a first time, wherein the amount of processed data is the estimated amount.

6. The method of claim 5, wherein the first time is a time when the data becomes first available for transmission by the UE to the network element.

7. The method of claim 1, wherein the first value has at least 5 bits.

8. The method of claim 2, wherein the second value has at least 5 bits.

9. The method of claim 1, wherein the BSR comprises a logic channel group identifier (LCG ID) associated with a logic channel group configured for transmission of data within the buffer.

10. The method of claim 1, wherein the BSR is a first BSR, the network element is a first network element and the amount of processed data is a first amount of processed data for transmission to the first network element via a first link, the method further comprising:
determining a second value based on a second amount of processed data for transmission to a second network element via a second link, wherein the processed data for transmission to the second network comprises at least one PDU with a PDCP header;
generating a second BSR comprising the second value;
transmitting the second BSR to the second network element.

11. A mobile communication device for transmitting data to a network element in a mobile communication system, comprising:
at least one processor;
at least one memory having instructions that, when executed by the at least one processor, cause the mobile communication device to perform a method for transmitting data by the mobile communication device to the network element, the method comprising:
determining a first value based on an amount of processed data having at least one protocol data unit (PDU) with a packet data convergence protocol (PDCP) header;
generating a buffer status report (BSR) comprising the first value;
transmitting the BSR to a network element.

12. The mobile communication device of claim 11, wherein the method further comprises determining a second value based on a total amount of the data available for transmission in the mobile communication device, wherein the BSR comprises the second value.

13. The mobile communication device of claim 11, wherein the at least one PDU comprises a radio link control (RLC) header.

14. The mobile communication device of claim 13, wherein the at least one PDU comprises a medium access control (MAC) header.

15. The mobile communication device of claim 11, wherein the method further comprises determining an estimated amount of processed data by a first time, wherein the amount of processed data is the estimated amount.

16. The mobile communication device of claim 15, wherein the first time is a time when the data becomes first available for transmission by the mobile communication device to the network element.

17. A method for transmitting data in a mobile communication system by a user equipment (UE), the method comprising:
receiving an uplink (UL) grant from a network element for transmitting a first amount of data;
determining whether a second amount of preprocessed data is smaller than the first amount;
when the second amount is determined to be smaller than the first amount:
transmitting padding bits with the preprocessed data, and an indication that unprocessed data is available for transmission to the network element.

18. The method of claim 17, wherein the preprocessed data comprises at least one protocol data unit (PDU) with a packet data convergence protocol (PDCP) header

19. The method of claim 18, wherein the preprocessed data further comprises at least one PDU having a radio link control (RLC) header and at least one PDU having a medium access control (MAC) header.

20. The method of claim 17, wherein the indication is a logical channel ID in a medium access control (MAC) header having a value configured to indicate that unprocessed data is available for transmission.
